(19) United States
(12) Patent Application Publication
(10) Pub. No.: US 2008/0136633 A1
(43) Pub. Date: Jun. 12, 2008

(54) Alarm apparatus

(76) Inventor: Willie C. Moss, Chattanooga, TN (US)

Correspondence Address: JAMES RAY & ASSOCIATES, 2640 PITCAIRN ROAD, MONROEVILLE, PA, 15146, US

(21) Appl. No.: 11/999,794

(22) Filed: Dec. 7, 2007

Related U.S. Application Data
(60) Provisional application No. 60/873,367, filed on Dec. 8, 2006.

(51) Int. Cl. G08B 13/14

(52) U.S. Cl. 340/568.1

(57) ABSTRACT

An alarm apparatus including a sensor pad for detecting a predetermined amount of pressure, a first transmitting means operably connected to such sensor pad for transmitting a first signal indicative of such sensor pad detecting an amount of pressure. A first power source supplies power to such sensor pad and first transmitting means. A receiving means receives such first signal when such receiving means is within a predetermined distance from such first transmitting means. A second transmitting means transmits a second signal indicative that the first signal is not being received by such receiving means. When such receiving means receives the second signal an alarm means will produce at least one of a predetermined sound, motion and visual display. A second power source is operably connected to the receiving means, the second transmitting means, and the alarm means for supplying power thereto.

### CROSS REFERENCE TO RELATED APPLICATION

This patent application is related to and claims priority from U.S. Provisional Patent Application Ser. No. 60/873,367 filed Dec. 8, 2006.

### FIELD OF THE INVENTION

The present invention relates, in general, to alarms and, more particularly, this invention relates to alarms to prevent an adult from accidentally leaving an infant or child strapped in a car seat.

### BACKGROUND OF THE INVENTION

Prior to the conception and development of the present invention, alarms, as are generally well known in the prior art, have been used by individuals to warn themselves and others of particular events. However, no alarms exist to warn an individual that he/she has left a child in a car seat.

### SUMMARY OF THE INVENTION

The present invention provides an alarm apparatus. Such alarm apparatus includes a sensor pad, manufactured from a first predetermined material and having a first predetermined size and first predetermined shape, for detecting a predetermined amount of such pressure.

A first transmitting means is operably connected to such sensor pad for receiving information from such sensor pad regarding detection of the predetermined amount of pressure and for transmitting a first signal indicative of such detection of pressure. A first power source is operably connected to such sensor pad and the first transmitting means for supplying power to such sensor pad and the first transmitting means.

A receiving means receives the first signal from the first transmitting means when such receiving means is within a predetermined distance from the first transmitting means.

A second transmitting means is operably connected to such receiving means for transmitting a second signal indicative that the first signal is not being received by such receiving means.

An alarm means is operably connected to such receiving means such that when such receiving means receives the second signal from such second transmitting means the alarm means will produce at least one of a predetermined sound, motion and visual display.

A second power source is operably connected to such receiving means, the second transmitting means, and the alarm means for supplying power thereto.

### OBJECTS OF THE INVENTION

It is, therefore, one of the primary objects of the present invention to provide an alarm that will warn caregivers that they have traveled too far from their vehicle without removing a child from the car seat within the vehicle.

Another object of the present invention is to provide an inexpensive means for securing the safety of children.

Still another object of the present invention is to provide a means for relieving worries and anxieties of parents who fear they or others may accidentally forget to remove a child from a car seat within a vehicle.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to a first embodiment of the inventions showing parts of the alarm apparatus.

FIG. 2 is a partial perspective view of the invention according to one embodiment of the invention showing the second housing.

FIG. 3 is a partial perspective view of the second housing according to a one embodiment of the invention.

FIG. 4 is a partial perspective view of the invention shown in FIG. 1 according to a one embodiment of the invention.

FIG. 5 is a partial perspective view of the second housing according to one embodiment of the invention.

FIG. 6 is a partial schematic view of the invention according to one embodiment of the invention.

FIG. 7 is a partial schematic view of the invention according to a first embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

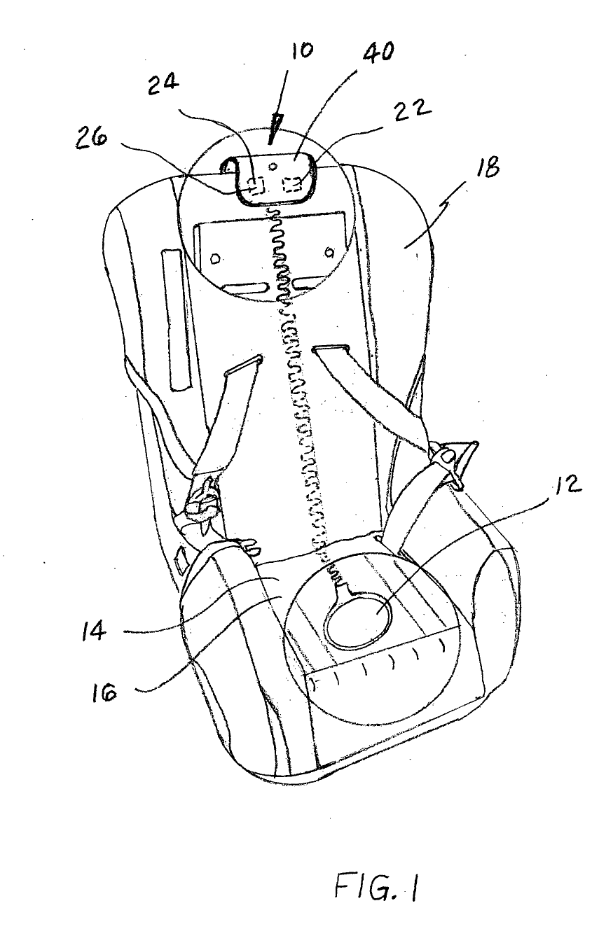

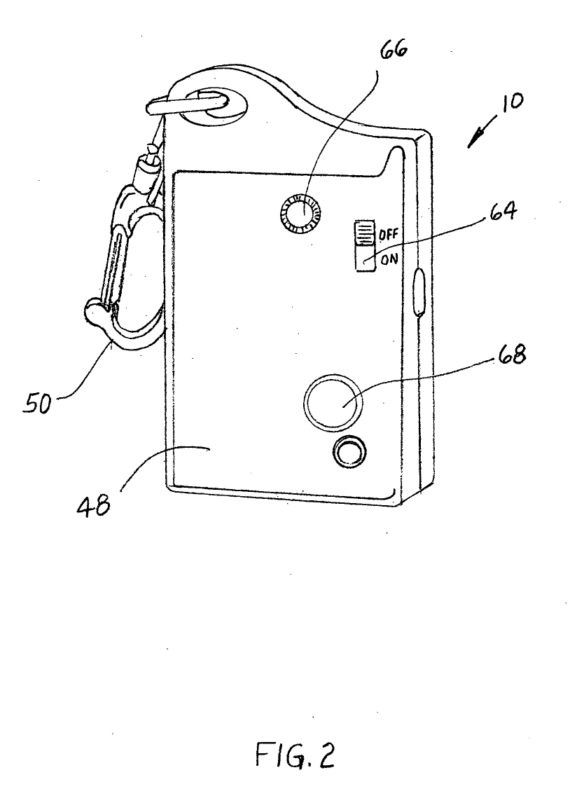

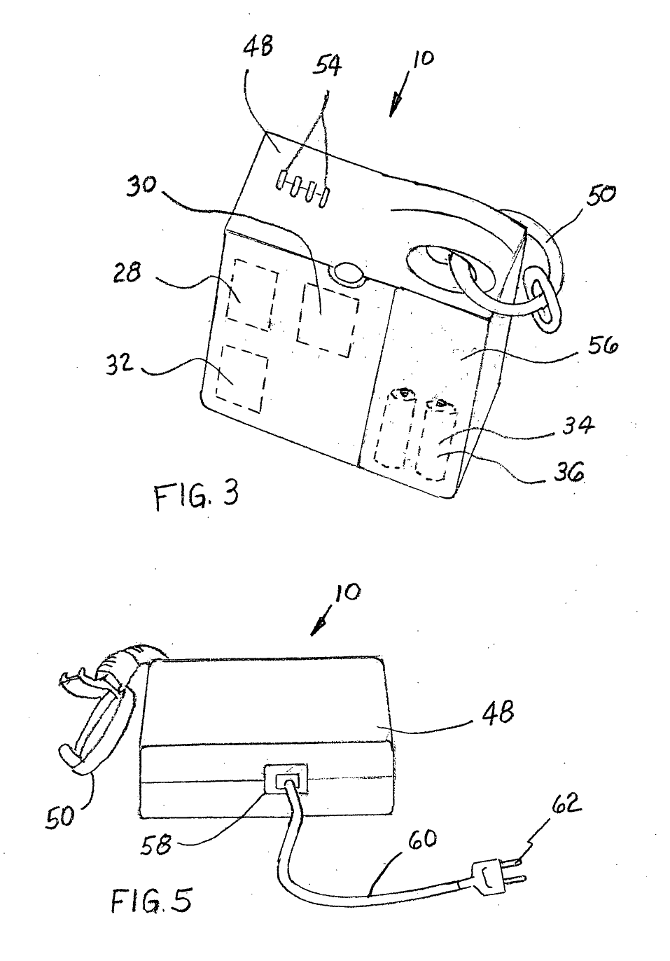

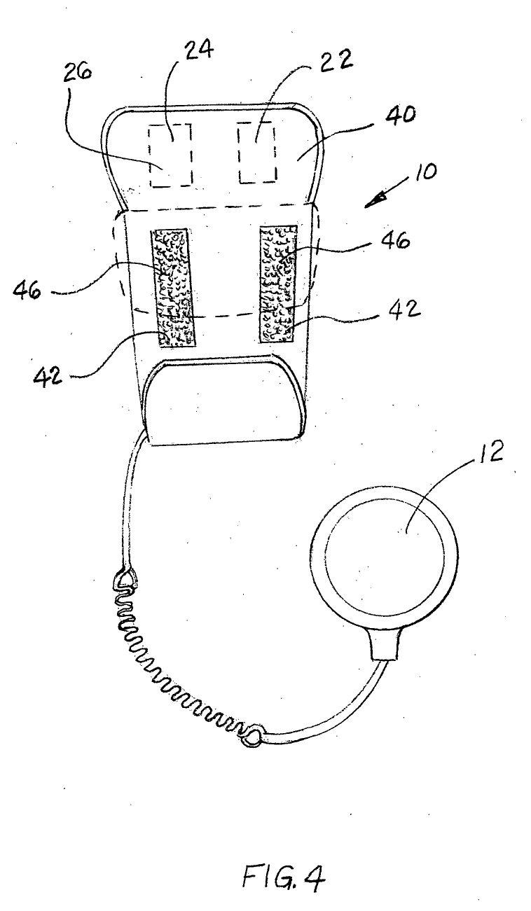

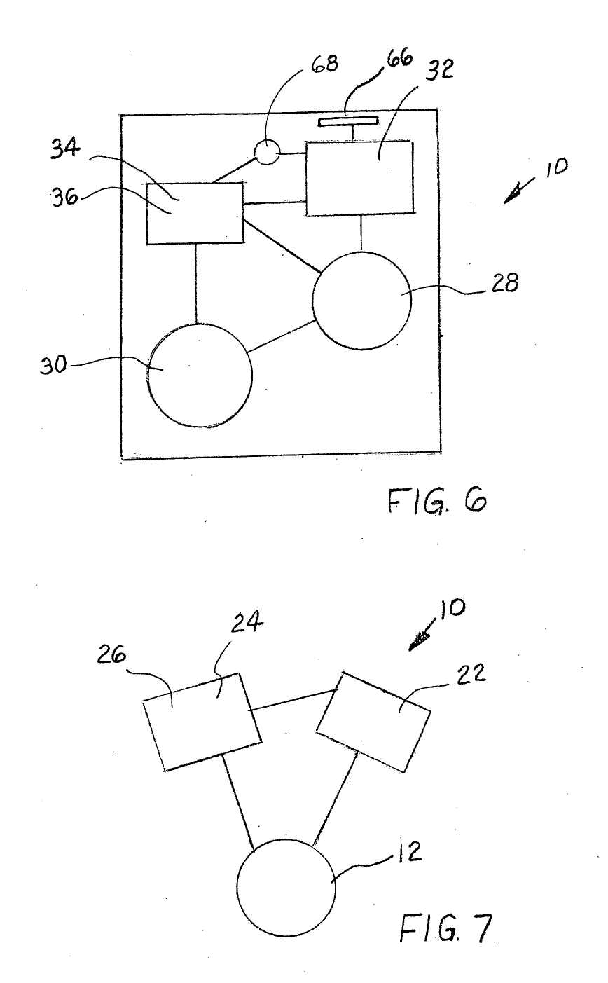

Reference is now made, more particularly, to FIGS. 1-4.

An alarm apparatus, generally designated 10, is provided. Such alarm apparatus includes a sensor pad 12 manufactured from a first predetermined material and having a first predetermined size and first predetermined shape for detecting a predetermined amount of pressure. It is presently preferred that such sensor pad 12 is capable of being placed unobtrusively underneath a seat covering 14 on a seat portion 16 of a child automobile seat 18. It is further presently preferred that such first predetermined shape is generally round.

A first transmitting means 22 is operably connected to the sensor pad 12 for receiving information from the sensor pad 12 regarding detection of such predetermined amount of pressure and for transmitting a first signal indicative of the detection of such pressure.

A first power source 24 is operably connected to the sensor pad 12 and the first transmitting means 22 for supplying power to the sensor pad 12 and the first transmitting means 22. It is presently preferred that such first power source 24 is at least one battery 26. It is presently most preferred that such at least one battery 26 is rechargeable.

Such alarm apparatus 10 further includes a receiving means 28 for receiving such first signal from the first transmitting means 22 when such receiving means 28 is within a predetermined distance from the first transmitting means 22.

A second transmitting means 30 is operably connected to the receiving means 28 for transmitting a second signal indicative that such first signal is not being received by the receiving means 28.

An alarm means 32 is operably connected to the receiving means 28 such that when the receiving means 28 receives the second signal from the second transmitting means 30 the alarm means 32 will produce at least one of a predetermined sound, motion and visual display.

A second power source 34 is operably connected to the receiving means 28, the second transmitting means 30, and the alarm means 32 for supplying power thereto. It is presently preferred that such second power source 34 is at least one battery 36. It is presently most preferred that such at least one battery 36 is rechargeable.

In the presently preferred embodiment of the invention, such alarm apparatus 10 is heat resistant. It is further presently preferred that such alarm apparatus is water resistant.

In the presently preferred embodiment of the invention, the first transmitting means 22 and the first power source 24 are contained within a first housing 40 manufactured from a second predetermined material and having a second predetermined size, a second predetermined shape. Such first housing 40 includes a securing means 42 for releasably attaching such first housing 40 to a child's automobile seat 18 at a predetermined location thereon. It is presently preferred that such securing means 42 is a hook and loop type fastening means 46.

In the preferred embodiment of the invention, the receiver 28, the second transmitting means 30, the alarm means 32, and the second power source 34 are contained within a second housing 48 manufactured from a second predetermined material and having a second predetermined size and a second predetermined shape.

It is presently preferred that such second housing 48 is releasably attached to a ring 50 for securing keys (not shown).

It is further presently preferred that such second housing 48 includes a plurality of apertures 54 for releasing sound emitted by the alarm means 32.

It is presently preferred that such second housing 48 includes an access panel 56 releasably attached to the second housing 48 to provide access to remove and recharge such second power source 34 as necessary.

It is presently most preferred that such second housing 48 includes an access means 58 for connecting the second power source 34 to a power cord 60 at a predetermined end thereof, such power cord 60 further including a means 62 for operably connecting such power cord 60 to a power supply (not shown) such that power is communicated from such power supply to such second power source 34.

In the presently preferred embodiment of the invention, such second housing 48 includes a switch means 64 disposed on the second housing 48.

It is further presently preferred that the second housing 48 includes a volume adjustment means 66 operably connected to the alarm means 32 for adjusting a sound level of the predetermined sound.

In the presently preferred embodiment of the invention, second housing 48 includes at least one light member 68 operably connected to the second power source 34 and the alarm means 32 such than when such alarm means 32 produces the visual display such at least one light member 68 will be energized.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An alarm apparatus comprising:
a. a sensor pad manufactured from a first predetermined material and having a first predetermined size and first predetermined shape for detecting a predetermined amount of pressure;
b. a first transmitting means operably connected to said sensor pad for receiving information from said sensor pad regarding detection of said predetermined amount of pressure and for transmitting a first signal indicative of said detection of said predetermined amount of pressure;
c. a first power source operably connected to said sensor pad and said first transmitting means for supplying power to said sensor pad and said first transmitting means;
d. a receiving means for receiving said first signal from said first transmitting means when said receiving means is within a predetermined distance from said first transmitting means;
e. a second transmitting means operably connected to said receiving means for transmitting a second signal indicative that said first signal is not being received by said receiving means;
f. an alarm means operably connected to said receiving means such that when said receiving means receives said second signal from said second transmitting means said alarm means will produce at least one of a predetermined sound, motion and visual display; and
g. a second power source operably connected to said receiving means, said second transmitting means, and said alarm means for supplying power thereto.

2. An alarm apparatus according to claim 1 wherein said sensor pad is capable of being placed unobtrusively underneath a a seat covering on a seat portion of a child automobile seat.

3. An alarm apparatus according to claim 1 wherein said first predetermined shape is generally round.

4. An alarm apparatus according to claim 1 wherein said alarm apparatus is heat resistant.

5. An alarm apparatus according to claim 1 wherein said alarm apparatus is water resistant.

6. An alarm apparatus according to claim 1 wherein said second power source is at least one battery.

7. An alarm apparatus according to claim 6 wherein said at least one battery is rechargeable.

8. An alarm apparatus according to claim 1 wherein said first power source is at least one battery.

9. An alarm apparatus according to claim 8 wherein said at least one battery is rechargeable.

10. An alarm apparatus according to claim 1 wherein said first transmitting means and said first power source are contained within a first housing manufactured from a second predetermined material and having a second predetermined size, a second predetermined shape, and said first housing includes a securing means for releasably attaching said first housing to a child's automobile seat at a predetermined location thereon.

11. An alarm apparatus according to claim 10 wherein said securing means is a hook and loop type fastening means.

12. An alarm apparatus according to claim 6 wherein said receiver, said second transmitting means, said alarm means, and said second power source are contained within a second housing manufactured from a second predetermined material and having a second predetermined size and a second predetermined shape.

13. An alarm apparatus according to claim 12 wherein said second housing is releasably attached to a ring for securing keys.

14. An alarm apparatus according to claim 13 wherein second housing includes a plurality of apertures for releasing sound emitted by said alarm means.

15. An alarm apparatus according to claim 12 wherein said second housing includes a switch means disposed on said second housing.

16. An alarm apparatus according to claim 12 wherein said second housing includes a volume adjustment means operably connected to said alarm means for adjusting a sound level of said predetermined sound.

17. An alarm apparatus according to claim 6 wherein said second housing includes an access panel releasably attached to said second housing to provide access to remove and recharge such second power source as necessary.

18. An alarm apparatus according to claim 7 wherein said second housing includes an access means for connecting said second power source to a power cord at a predetermined end thereof, said power cord further including a means for operably connecting said power cord to a power supply such that power is communicated from such power supply to said second power source.

19. An alarm apparatus according to claim 12 wherein said second housing includes at least one light member operably connected to said second power source and said alarm means such than when such alarm means produces said visual display said at least one light member will be energized.
